(19) United States
(12) Patent Application Publication
(10) Pub. No.: US 2026/0222190 A1
(43) Pub. Date: Jul. 30, 2026

(54) WARP-COLLECTIVE INSTRUCTIONS TO ACCELERATE CRYPTOGRAPHIC PRIMITIVES

(71) Applicant: NVIDIA Corp., Santa Clara, CA (US)

(72) Inventors: Michael B Sullivan, Austin, TX (US); Santosh Ghosh, Hillsboro, OR (US); Daniel Robert Johnson, Austin, TX (US); Gookwon Suh, Lexington, MA (US); Cherin Joseph, San Francisco, CA (US); Ming Yiu Siu, Sammamish, WA (US)

(73) Assignee: NVIDIA Corp., Santa Clara, CA (US)

(21) Appl. No.: 19/461,433

(22) Filed: Jan. 27, 2026

Related U.S. Application Data
(60) Provisional application No. 63/749,907, filed on Jan. 27, 2025.

(51) Int. Cl. H04L 9/08; G06F 7/58; G06N 3/08

(52) U.S. Cl. CPC H04L 9/0869; G06N 3/08; G06F 7/588

(57) ABSTRACT

Mechanisms for the generation of randomized sequences of substantial length the generation of which involves the frequent exchange of long bit sequences between threads in a multiprocessor. The mechanisms accelerate in hardware the swapping of long sequences between threads that in conventional systems slows the generation of the sequences down and increases the power consumption needed to generate the sequences.

### CROSS REFERENCE TO RELATED APPLICATIONS

This application claims priority and benefit under 35 U.S.C. 119 (e) of U.S. Application Ser. No. 63/749,907, “WARP-COLLECTIVE INSTRUCTIONS TO ACCELERATE CRYPTOGRAPHIC PRIMITIVES”, filed on Jan. 27, 2025, the contents of which are incorporated herein by reference in their entirety.

### BACKGROUND

Pseudo-random number generators may be utilized in computer systems to generate deterministic sequences that appear, to an acceptable degree, as statistically random. Pseudo-random number generators may be computationally efficient but may generate sequences that can, with sufficient analysis, be distinguished from true randomness.

Crypto-secure pseudo-random number generators may be utilized in applications where a higher degree of randomness is called for, at the cost of being slower or requiring a greater degree of computational resources to implement than do pseudo-random number generators. Crypto-secure pseudo-random number generators generate sequences that cannot be practically distinguished from truly random sequences such that for k bits of the generated sequence, no polynomial-time computer algorithm may predict the (k+1)^{th} bit with non-negligible advantage over 50% accuracy.

Crypto-secure pseudo-random number generators thus generate sequences that may be more secure for applications such as cryptography, but at the cost of lower computational efficiency. Crypto-secure pseudo-random number generators may be utilized, for example, in privacy-preserving multi-party computation applications and fully homomorphic encryption applications, or for private information exchange between client and server devices over data networks.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an aspect of the subject matter in accordance with one embodiment.

FIG. 2 depicts a ChaCha algorithm at a high-level.

FIG. 3 depicts an example of parallelizing a secure 20-round ChaCha workload across 16 threads.

FIG. 4A depicts an example of parallelizing an insecure 4-round ChaCha workload across 16 threads.

FIG. 4B depicts an example of parallelizing an insecure 2-round ChaCha workload across 16 threads.

FIG. 5A depicts a hardware acceleration unit for a ChaCha quarter round.

FIG. 5B depicts four ChaCha quarter rounds carried out utilizing one or more of the hardware acceleration units depicted in FIG. 5A.

FIG. 5C depicts an exemplary 2-round ChaCha workload computation utilizing four hardware acceleration units.

FIG. 5D depicts a complete ChaCha workload computation utilizing 16 hardware acceleration units.

FIG. 6 depicts the use of multiplexers to route state values between hardware quarter round units in one embodiment.

FIG. 7 depicts a Keccak hardware acceleration unit in one embodiment.

FIG. 8 depicts an exemplary utilization of a Keccak hardware acceleration unit with cross thread reduction.

FIG. 9 depicts a parallel processing unit in accordance with one embodiment.

FIG. 10 depicts a general processing cluster in accordance with one embodiment.

FIG. 11 depicts a memory partition unit in accordance with one embodiment.

FIG. 12 depicts a streaming multiprocessor in accordance with one embodiment.

FIG. 13 depicts a processing system in accordance with one embodiment.

FIG. 14 depicts an exemplary processing system in accordance with another embodiment.

### DETAILED DESCRIPTION

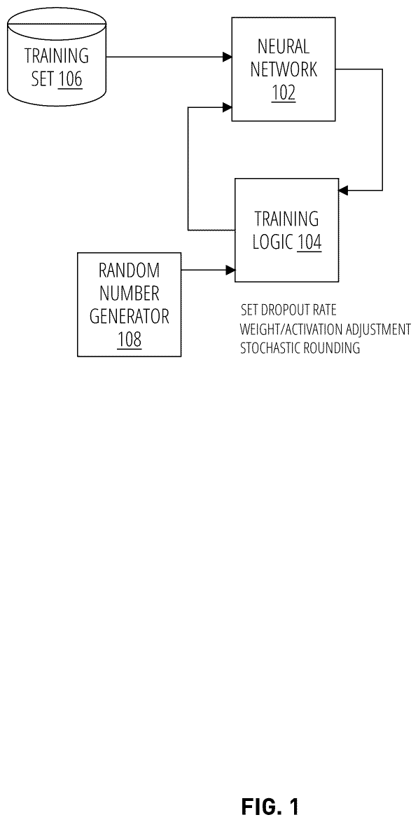

Referring to FIG. 1, dropout is a regularization technique utilized during the training of neural networks 102 to mitigate overfitting. During forward propagation of activations through the neural network, a fraction of neurons in one or more layers (e.g., p, the dropout percent or rate) may be temporarily “dropped” by the network's training logic 104, meaning they are not activated.

During training of the neural network 102 with a training set 106, dropout mechanisms may drop a ‘random’ fraction of the neurons in various layers. In the general case, this may be done during both forward and backward passes. Dropout mechanisms may discourage the network from becoming overly reliant on any specific neuron. Dropout may commonly be applied for example in fully connected layers of neural network models, such as attention layers.

The dropout rate p may be configured in the training logic 104 as a network hyperparameter representing the probability of dropping out a neuron. When neurons are dropped out, the neural network 102 is effectively trained with various “thinned” versions of itself, which helps prevent complex co-adaptations where neurons only work well with specific other neurons. If the sequences utilized to select the neurons to drop are not sufficiently randomized, the neural network 102 may be configured (may ‘learn’) undesirable statistical patterns.

The accuracy and performance of neural network model training may thus benefit from the utilization of computationally efficient and highly randomized sequence generators. The number of bits in the generated sequence may determine the precision of the dropout rate p.

The sequences produced by random number generator 108 may be characterized by their fidelity (degree of randomness) and their bit length (precision).

Stochastic rounding is another mechanism that may be utilized during the configuration of neural network models. Stochastic rounding mechanisms may for example probabilistically round values either up or down to the nearest integer value, e.g.:

$$round ( x ) = \{ \begin{matrix}floor ( x ) & with probability floor ( x ) - x + 1 \\ floor ( x ) + 1 & with probability x - floor ( x )\end{matrix}$$

Due to their stochastic nature, stochastic rounding mechanisms may also utilize random number generators 108.

One example of a commonly-used crypto-secure pseudo-random number generator is the ChaCha20 mechanism. ChaCha20 is a stream cipher that operates on a 512-bit state consisting of four 32-bit words for the key, four for the counter and nonce, four for constants, and four more derived during operations. A 16-word state matrix is initialized using a 256-bit key, a 32-bit counter, a 96-bit nonce, and a set of fixed constants. The core operation of ChaCha20 involves rotating, adding, and XORing operations applied to four words of the state. This function is applied repeatedly over many rounds to scramble the state. ChaCha20 typically performs 20 rounds (10 column rounds and 10 diagonal rounds) where each round applies the quarter-round function across different sets of words in a specific pattern. This enhances diffusion and ensures security. After completing the rounds, the original state is added to the transformed state to produce the final state. The resultant words may be serialized to produce the keystream blocks. For encryption, the keystream may be XORed with the plaintext to generate ciphertext. For decryption, the ciphertext may be XORed with the same keystream to recover the plaintext.

Another example of a commonly-used crypto-secure pseudo-random number generator is the Keccak mechanism. Keccak is a cryptographic family of hash mechanisms. It is distinct from the SHA-2 family and utilizes a “sponge” construction, which absorbs the input message into an internal state and then squeezes the output hash from that state. Keccak operates with a permutation-based structure rather than relying on linear or nonlinear maps used in other hash mechanisms. Keccak performs operations on a fixed-size state which is represented as a 3-dimensional array of bits with dimensions 5×5×W, where W is determined by the security level. Keccak alternates between absorbing message blocks and squeezing output until the desired hash length is reached. It applies a series of five permutation steps—theta, rho, pi, chi, and iota—which systematically transform the state to achieve diffusion and security.

Dropout, stochastic rounding, crypto-secure pseudo-random number generation, and other common operations in computer workloads may have in common the generation of randomized sequences of substantial length and (in multithreaded applications) frequent exchange of long bit sequences between threads. The swapping of long sequences between threads tends to slow the mechanisms down, and also may substantially increase the power consumption of the mechanisms.

The drawings may be understood in conjunction with the following algorithms.
Listing 1 depicts a conventional implementation (utilizing the Nvidia® CUDA programming model) of a ChaCha20 workload in a multithreaded parallel processing unit.
Listing 2 depicts an implementation (in CUDA) of a ChaCha20 workload in a multithreaded parallel processing unit, utilizing mechanisms disclosed herein (e.g., a hardware acceleration unit invoked by an Instruction Set Architecture cryptographic primitive enhancement, e.g., chacha2.sync.aligned.u32).
Listing 3 depicts an implementation (in CUDA) of a Keccak workload in a multithreaded parallel processing unit, utilizing mechanisms disclosed herein (e.g., a hardware acceleration unit invoked by an Instruction Set Architecture cryptographic primitive enhancement, e.g., keccakl.sync.aligned).

LISTINGS

```
            Listing 1 - Conventional ChaCha20(Multithreaded)
__device__ inline uint32_t rot132(uint32_t x, int n) {
    return (x << n) | (x >> (32 − n));
}
__device__ inline void quarterRound(uint32_t &a, uint32_t &b,
uint32_t &c, uint32_t &d) {
    a += b; d \hat{ }= a; d = rot132 (d, 16);
    c += d; b \hat{ }= c; b = rot132 (b, 12);
    a += b; d \hat{ }= a; d = rot132 (d, 8);
    c += d; b \hat{ }= c; b = rot132 (b, 7);
}
__global__ oid kernel_chacha20_sw(uint32_t *data, const
uint32_t *initState) {
    if (threadIdx.x == 0) {
        // Local arrays for the state and the original input
        uint32_t x[16], orig[16];
        // Load 16 words (512 bits) into local arrays
    #pragma unroll
    for (int i = 0; i < 16; i++) {
        x[i] = data[i];
        orig[i] = initState[i];
    }
    // Perform 10 double rounds (20 total)
    for (int i = 0; i < 10; i++) {
          // Odd round
        quarterRound(x[0], x[4], x[8], x[12]);
        quarterRound(x[1], x[5], x[9], x[13]);
        quarterRound(x[2], x[6], x[10], x[14]);
        quarterRound(x[3], x[7], x[11], x[15]);
        // Even round
        quarterRound(x[0], x[5], x[10], x[15]);
        quarterRound(x[1], x[6], x[11], x[12]);
        quarterRound(x[2], x[7], x[ 8], x[13]);
        quarterRound(x[3], x[4], x[9], x[14]);
    }
    // Add the original state back to the result
    #pragma unroll
    for (int i = 0; i < 16; i++) {
        x[i] += orig[i];
    }
    // Write the results back to the data array
    #pragma unroll
    for (int i = 0; i < 16; i++) {
        data[i] = x[i];
    }
}
}
```

Listing 2 - Hardware-Accelerated ChaCha20

```
__global__ void kernel_chacha20_hw(uint32_t *data, const
uint32_t *initState) {
        int idx = threadIdx.x;
        // Convert pointer to a register the PTX can use
        uint32_t dataReg = data[idx];
        uint32_t initReg = initState[idx];
        // Perform 10 double rounds (20 total)
        for (int i = 0; i < 10; i++) {
            // Inline PTX call:
            // “chacha2.sync.aligned”:
            // * Perform 2 chacha rounds per warp-
collective call
            // * A 32-thread warp will execute two of these
operations per instruction
            // * Threads 0..15 hold the inputs/outputs
of the first operation
            // * Threads 16...31 hold the
inputs/outputs of the second operation
            // * .sync: All threads in the warp execute the
chacha2 instruction together
            // * .aligned: The data must be laid out in a
canonical format.
            // “+r” means input and output register is the
same, and it is an integer register
            asm volatile(
              “{\n\t”
              “ chacha2.sync.aligned.u32 ”
              “ %0;\n\t”
              “}\n”
                : “+r”(dataReg) // %0 = destination
            );
        }
        // Add original state to finalize the ChaCha output
        dataReg = dataReg + initReg;
        // Modify data in-place
        data [idx] = dataReg;
}
```

Listing 3 - Hardware Accelerated Keccak

```
__global__ void kernel_sha3_keccakf(uint64_t *data) {
    int idx = threadIdx.x;
    // Convert pointer to a 64-bit register the PTX can use
    uint64_t dataReg = data[idx];  // Changed to uint64_t to
match 64b input/output
    // Perform 24 permutation rounds
    for (int round_idx = 0; round_idx < 24; round_idx++) {
        // Inline PTX call:
        // “keccak1.sync.aligned”:
        // * Performs 1 keccak-f[1600] round per warp-
collective call
        // * A 32-thread warp executes one of these
operations per instruction
        // * Threads 0..24 hold the 64b inputs/outputs
of the first operation
        // * The round index must also be passed to the
instruction
        // * .sync: All threads in the warp execute the
keccak instruction together
        // * .aligned: The data must be laid out in a
canonical format.
        // “+1” means input and output register is the same,
and it is a 64-bit integer register
        asm volatile(
          “{\n\t”
          “ keccak1.sync.aligned.u64 ”
          “ %0, %1;\n\t” // %0 = 64-bit dataReg, %1 =
32-bit round_idx
          “}\n”
            : “+1”(dataReg) // %0 = destination (64-bit
input/output)
            : “r”(round_idx) // %1 = round index (32-bit
input)
        );
    }
    // Modify data in-place
    data[idx] = dataReg;
}
```

The Keccak round function is called back-to-back (no column/diagonal indexing as with ChaCha. Modifying Listing 3 for hardware-accelerated Keccak to use a different number of rounds per instruction involves only a modification to a single line:

```
  // Perform 24 permutation rounds (1x rounds
per instruction)
  for (int round_idx = 0; round_idx < 24; round_idx++) {
```

For example, for a hardware instruction that performs 2x Keccak-f [1600] rounds per instruction:

```
    // Perform 12 permutation double-rounds (2x rounds per
instruction)
  for (int round_idx = 0; round_idx < 12; round_idx++) {
```

For 4x rounds per instruction:

```
    // Perform 6 permutation quadruple-rounds (4x rounds per
instruction)
  for (int round_idx = 0; round_idx < 6; round_idx++) {
    and so on.
```

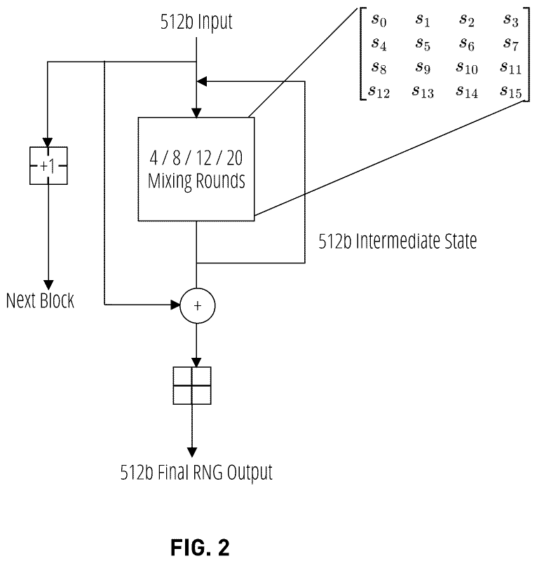

FIG. 2 depicts a ChaCha algorithm at a high-level. The algorithm may be implemented by forming a 4×4 matrix containing fixed constants, a secret key, a block counter, and a nonce (‘number used once’). The state matrix may comprise sixteen 32-bit words for a total of 902 bits of state.

A common implementation of ChaCha comprises an initial state matrix organized as follows:
Row 0 (s0 . . . s3): 4 constants
Row 1 and 2 (s4 . . . s11): 256-bit secret key
Row 3 (s12 . . . s15): block counter (s12) and nonce (s13 . . . s15)

A mixing operation is performed on groups of four values (add, XOR, rotate) of the matrix in a specific pattern that alternates between columns and diagonals. After a number (e.g., 4, 8, 12, or 20) such rounds, the original matrix (initial state) is added to the mixed one (output state), producing 64 bytes (512 bits) of randomized data. For cryptography applications, those 64 bytes may be XORed with the plaintext to encrypt (and again to decrypt). In some applications, the counter may be increased and the process repeated for the next input.

A core of the mixing operation is the quarter round (herein, “QR”). A quarter round scrambles four 32-bit words (a, b, c, d) with addition/rotation/XOR (herein, “ARX”) operations.

QR(a, b, c, d):

$$a = a + b ; d = d XOR a ; d = R O T L ( d , 16 )$$

$$c = c + d ; b = b XOR c ; b = R O T L ( b , 12 )$$

$$a = a + b ; d = d XOR a ; d = R O T L ( d , 8 )$$

$$c = c + d ; b = b XOR c ; b = R O T L ( b , 7 )$$

where + is addition modulo 2³², XOR is bitwise XOR, and ROTL (x, r) is rotate-left by r bits. The constants 16, 12, 8, 7 provide diffusion and resistance to cryptanalysis. After a number of quarter-rounds, every output bit becomes a complex function of many input bits.

A full ChaCha round comprises 4 column quarter rounds and 4 diagonal quarter rounds. Column quarter round:
QR (s0, s4, s8, s12)//column 0
QR (s1, s5, s9, s13)//column 1
QR (s2, s6, s10, s14)//column 2
QR (s3, s7, s11, s15)//column 3

### Diagonal Quarter Round:

QR (s0, s5, s10, s15)//main “diagonal”
QR (s1, s6, s11, s12)
QR (s2, s7, s8, s13)
QR (s3, s4, s9, s14)

A pair round comprises the execution of one column round and one diagonal round. ChaCha20 for example comprises 10 pair rounds, for a total of 20 rounds. At a high level, ChaCha_N (where N=4, 8, 12 . . . ) operates as follows:

```
For i from 1 to N:
  Do column round (4 QRs)
  Do diagonal round (4 QRs)
```

Add initial state to the output/working state word-wise:

For each i:
working[i] = working[i] + state[i] (mod 2\hat{ }32)

For random number generation, serialize working [0 . . . 15] into 64 bytes (little endian). For cryptography, this may also function as a keystream block that is XORed with the plaintext to produce a ciphertext block. The block counter may then be incremented and the algorithm repeated on the next 512-bit block.

One challenge with implementing the ChaCha algorithm in machine architectures is the size of the initial and output states and the algorithm's register usage requirements. ChaCha utilizes a 1024 bit total state comprising the 512 bit initial state a 512 bit working/output state.

In highly parallelized data processors such as graphics processing units (GPUs) and some central processing units, it may be impractical to propagate this much state to a SIMT (per-thread) instruction. SIMT refers to Single Instruction, Multiple Threads, a parallel computing architecture commonly used in GPUs where a single instruction is applied simultaneously to multiple threads, enabling efficient execution of workloads such as ChaCha that may be parallelized to some extent.

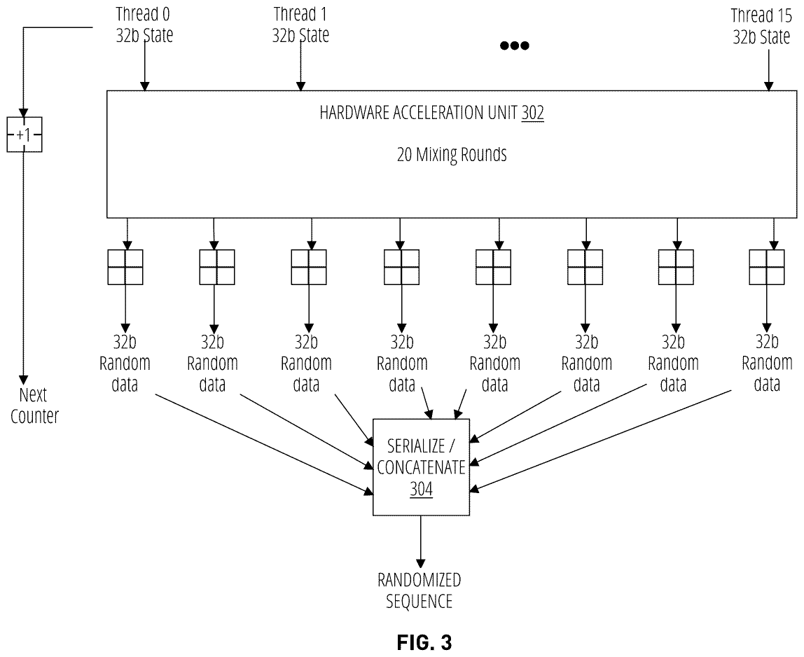

FIG. 3 depicts an example of parallelizing a crypto-graphically secure 20-round ChaCha workload across 16 threads, e.g., a “warp” in a hardware acceleration unit 302 of a data processor. Within each mixing round, each thread may share 32 bits of state information (for a total of 512 bits of state) with all the other threads. The output of a round (except the final one) is input as state to the next round. For each parallel thread working on the algorithm, one register may be utilized to store the initial state, and two registers store the working/output state. The final 32 bit outputs from the sixteen threads may be serialized or concatenated (or otherwise combined) to generate the final 512-bit randomized output sequence (serializer 304).

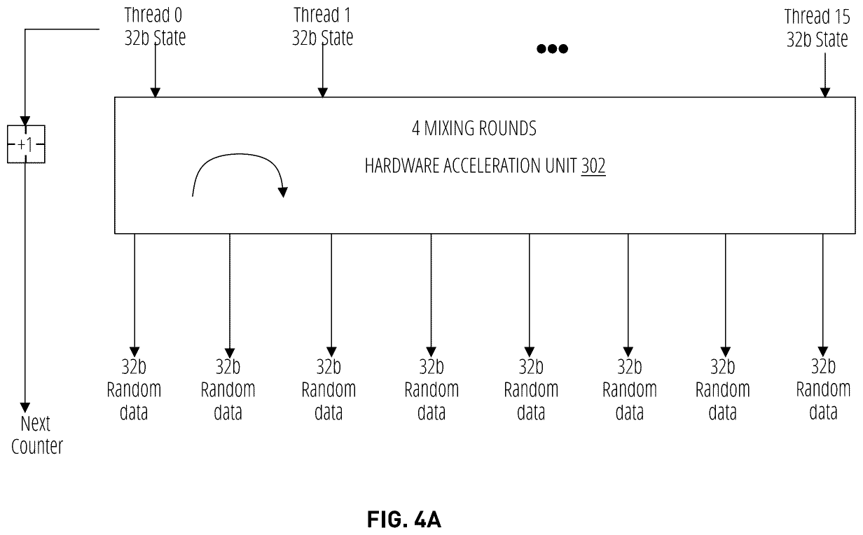

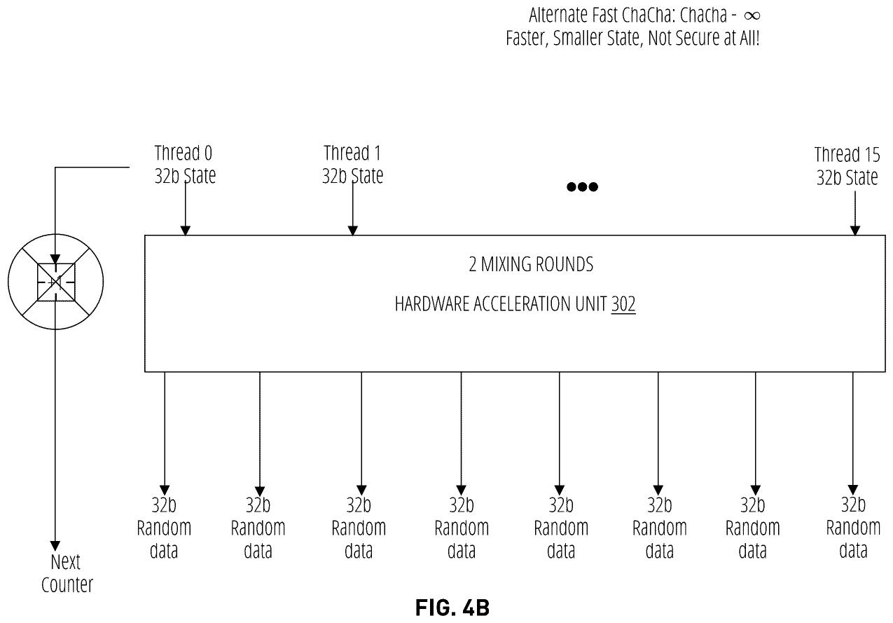

FIG. 4A depicts an example of parallelizing an insecure 4-round ChaCha workload across 16 threads and FIG. 4B depicts an example of parallelizing an insecure 2-round ChaCha workload across 16 threads. These workloads may execute faster than a secure ChaCha workload, but do not produce a result that is cryptographically secure. However the insecure outputs may be sufficiently random for some applications, such as dropout utilized during the training of neural networks, and stochastic rounding.

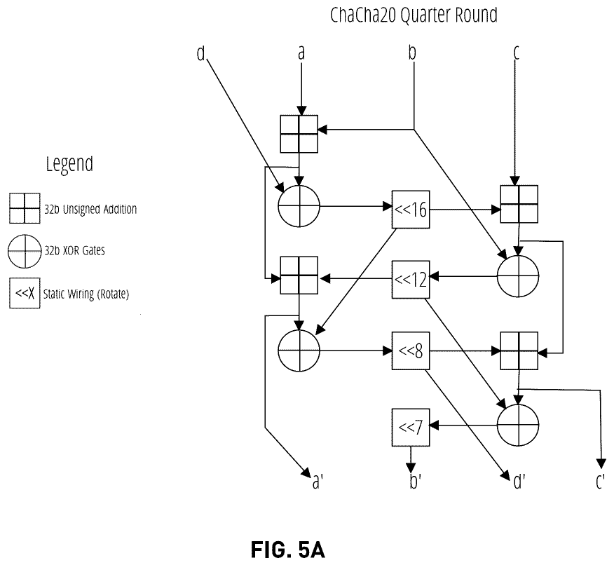

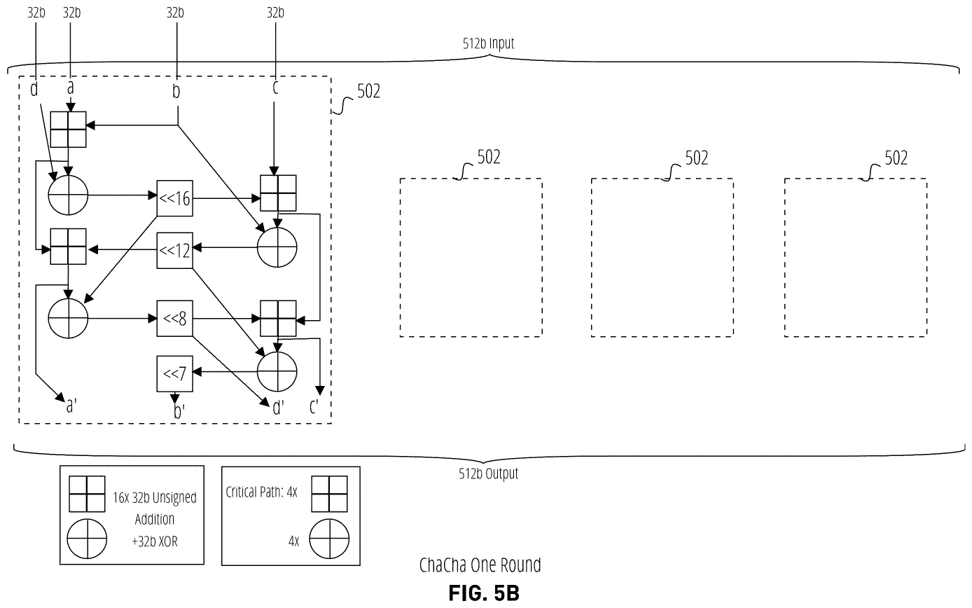

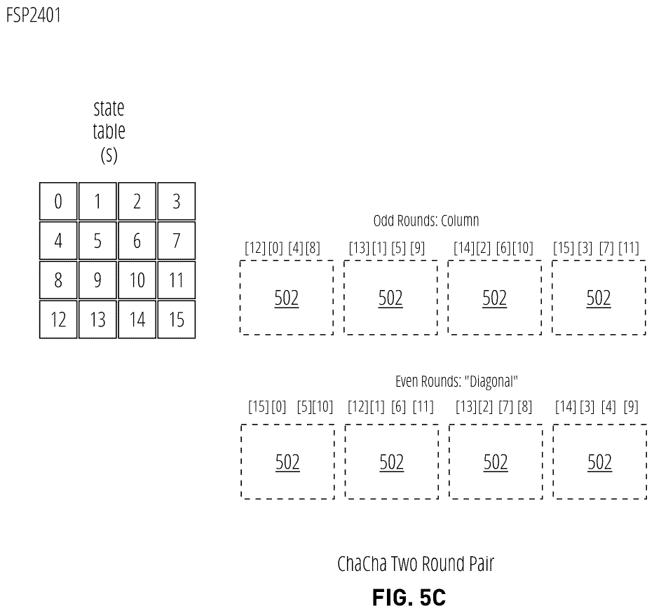

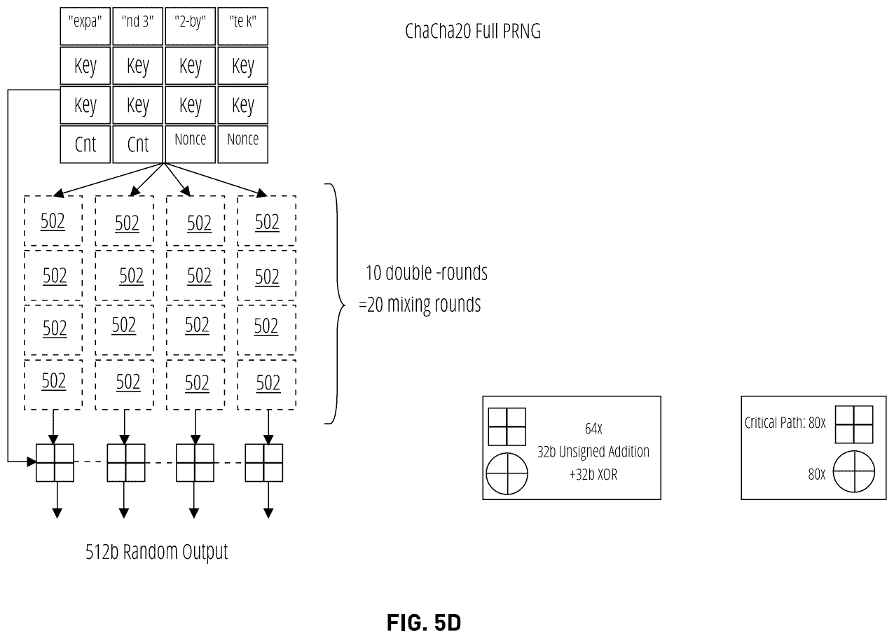

FIG. 5A depicts a hardware acceleration unit for a ChaCha20 quarter round in one embodiment. The hardware acceleration unit embodiment utilizes only 32 bit adders, shifters for bit rotation, and XOR gates, making it highly area-efficient.

Recall that a quarter round QR (a, b, c, d) comprises:

$$□ a = a + b ; d = d XOR a ; d = R O T L ( d , 16 )$$

$$□ c = c + d ; b = b XOR c ; b = R O T L ( b , 12 )$$

$$□ a = a + b ; d = d XOR a ; d = R O T L ( d , 8 )$$

$$□ c = c + d ; b = b XOR c ; b = R O T L ( b , 7 )$$

where + is addition modulo 2³², XOR is bitwise XOR, and ROTL (x, r) is rotate-left by r bits.

The hardware acceleration unit further implements state sharing between quarter rounds of the ChaCha workload. For even greater area efficiency, the shifters may in some embodiments be implemented solely with static metal wiring tracks.

FIG. 5B depicts parallel execution of a ChaCha round utilizing four hardware quarter round units 502. The hardware quarter round units 502 may be utilized in different manners depending on the level of acceleration desired, traded off against silicon area consumed. For example, a single hardware quarter round unit 502 may be activated four times serially per full round, or (as depicted) four hardware quarter round units 502 may be activated in parallel once per full round.

Outputs of each quarter round or round may be arranged for input to the next iteration through the hardware acceleration unit(s) in software, e.g., using thread shuffling mechanisms. For example in CUDA environments, various warp shuffle operations (shfl.x.y) may be executed to enable threads within the same warp to directly read each other's register values without using shared memory.

Listing 4—Software-based column/diagonal shuffling with single-round ChaCha instruction

```
// Each thread holds one 32-bit element of the ChaCha state.
// The chachal instruction performs one quarter-round on
groups of 4 threads. // Software shuffles rearrange
data between column and diagonal rounds.
// Shuffle lookup tables (in shared memory or registers)
// COL_TO_DIAG: rearrange from column to diagonal layout
// DIAG_TO_COL: rearrange from diagonal to column layout
constexpr int COL_TO_DIAG[16] = {0, 1, 2, 3, 5, 6, 7, 4, 10, 11,
8, 9,15,12,13,14};
constexpr int DIAG_TO_COL[16] = {0, 1, 2, 3, 7, 4, 5, 6, 10, 11,
8, 9,13,14,15,12};
int lane = threadIdx.x & 0xF;
int half = threadIdx.x & 0x10;
// 10 iterations of (column round + diagonal round) = 20
rounds total
  for (int i = 0; i < 10; i++) {
    // Column round (data already in column layout)
    asm volatile(
      “chacha1.sync.aligned.u32 %0;\n”
      : “+r”(dataReg)
    );
    // Shuffle: column −> diagonal layout
    dataReg = __ shfl_sync(0xFFFFFFFF, dataReg,
      COL_TO_DIAG[lane] + half);
    // Diagonal round
    asm volatile(
      “chacha1.sync.aligned.u32 %0;\n”
        : “+r”(dataReg)
    );
    // Shuffle: diagonal −> column layout
    dataReg = __shfl_sync(0xFFFFFFFF, dataReg,
        DIAG_TO_COL[lane] + half);
  }
// Add original state to finalize the ChaCha output
dataReg = dataReg + initReg;
```

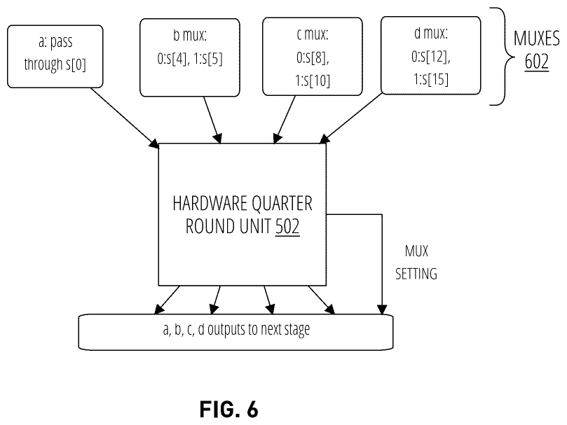

Outputs of an iteration may also be shuffled for the next iteration in hardware, e.g., using multiplexers for inputs b, c, and d as depicted in FIG. 6.

Listing 5—//Hardware-based column/diagonal selection with single-round ChaCha instruction

```
        // Each thread holds one 32-bit element of the ChaCha
state.
        // The chachal instruction has an immediate operand
specifying column (0) or diagonal (1).
        // Hardware muxes internally select the correct input
indices based on this immediate.
        // No software shuffles required − data stays in
canonical (column) layout throughout.
        // 10 iterations of (column round + diagonal round) =
20 rounds total
        for (int i = 0; i < 10; i++) {
            // Column round: diagonal=0 selects column
indexing via hardware muxes
            asm volatile(
                “chacha1.sync.aligned.u32 %0, 0;\n” // 0 =
column round
                : “+r”(dataReg)
            );
            // Diagonal round: diagonal=1 selects diagonal
indexing via hardware muxes
            asm volatile(
                “chacha1.sync.aligned.u32 80, 1;\n” // 1 =
diagonal round
                : “+r”(dataReg)
            );
        }
        // Add original state to finalize the ChaCha output
        dataReg = dataReg + initReg;
```

FIG. 5C depicts an exemplary 2-round ChaCha20 workload computation utilizing four hardware quarter round units 502.

FIG. 5D depicts a complete ChaCha20 workload computation utilizing 16 hardware quarter round units 502. The workload comprises 10 double-rounds (20 mixing rounds). For added security (not randomness), the output of the last round may be added to the original input to make the 512-bit output non-invertible.

Listing 6—Full ChaCha20 in a single instruction (all 20 rounds in hardware)

```
// Each thread holds one 32-bit element of the ChaCha state.
// The chacha20 instruction performs all 20 rounds
internally.
// Hardware handles all column/diagonal transitions via
internal muxes.
asm volatile(
    “chacha20.sync.aligned.u32 80;\n”
    : “+r”(dataReg)
    );
    // Add original state to finalize the ChaCha output
    dataReg = dataReg + initReg;
```

FIG. 6 depicts the use of multiplexers 602 to route state values between hardware quarter round units 502. In addition to the permuted input state, the hardware quarter round unit 502 may output a setting to the multiplexers 602 for the next stage, for routing state information between stages/rounds.

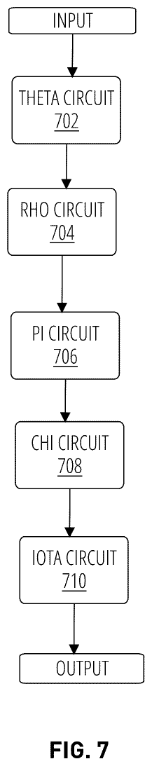

FIG. 7 depicts a Keccak hardware acceleration unit in one embodiment. The hardware acceleration unit may be utilized by many threads executing in parallel. For example, each of 32 threads may contribute 50 bits each of a 1600 bit input, which advantageously occupied an entire warp on Nvidia GPU platforms and generates 32 thread-local states (e.g., for a cryptographic secure PRNG). In another example, each of 25 threads may contribute 64 bits each of a 1600 bit input, which advantageously utilizes a full 64-bit bus when writing to/from memory.

The Keccak hardware acceleration unit comprises multiple sub-circuits arranged in parallel to transform a 1600 bit input into a highly randomized 1600 bit output. The input is first processed through a theta circuit 702 (θ) comprising a number (e.g., ~3200) of XOR2 gates and fixed wiring to implement the bit rotation.

The theta circuit 702 generates column parity (C) values from the input A values according to
C(x)=A[x,0]\hat{ }A[x,1]\hat{ }A[x,2]\hat{ }A[x,3]\hat{ }A[x,4] where x is a column of a 5×5 input matrix/table. The theta circuit 702 further transforms the C values into D values according to
D[x]=C[x−1]\hat{ }ROT(C[x+1],1) where ROT indicates bit rotation. The theta circuit 702 then applies the generated D values to the input A according to

$${A}^{′} [ x , y ] = {A [ x , y ]}^{∧} D [ x ] .$$

The rho circuit 704 (p) rotates each A[x,y] input by a fixed offset r[x,y]=(1,1,3,6 . . . ) as per the Keccak algorithm:
A′[x,y]=ROT (A[x,y], r[x,y]). The rho circuit 704 may be implemented entirely with fixed wiring configured to implement the rotations.

The pi circuit 706(π) permutes the lane positions according to:
A′[y, 2x+3y]=A[x,y]. The pi circuit 706 may be implemented entirely with fixed wiring.

The chi circuit 708 (χ) implements non-linear, per-input-row mixing, according to:
A′[x,y]=A[x,y]\hat{ }(!A[x+1,y]&A[x+2,y]). The chi circuit 708 may be implemented with a number (e.g., 1600) of XOR2 gates, a same number of AND2 gates and inverters.

The iota circuit 710 (ι) performs an XOR of lane 0 with a constant value RC[index] that may vary per Keccak round:
A′[0,0]=A[0,0]\hat{ }RC[index]. The iota circuit 710 may be implemented with a number, e.g., 64, or XOR gates.

A single Keccak-f [1600] round comprises 1600 bits of input state and 1600 bits of output state. State may be implemented as a table, vector, or matrix. For example state for Keccak-f [1600] may be implemented as a 5×5 matrix/table of 64 bit values. Each Keccak-f [1600] round comprises five stages, herein referred to as θ (Theta), ρ (Rho), π (Pi), χ (Chi), and ι (Iota).

Unlike ChaCha, with Keccak only “column” indexing is utilized; there is no column/diagonal swapping between rounds.

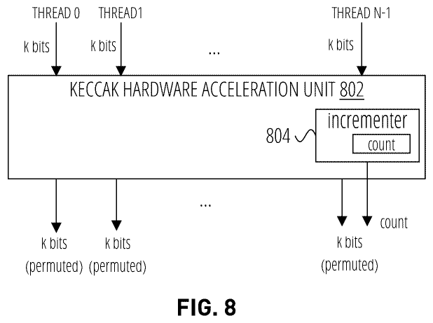

FIG. 8 depicts an exemplary utilization of a Keccak hardware acceleration unit 802 with cross thread reduction. The Keccak hardware acceleration unit 802 may be operated in parallel by a number N of threads utilizing a pair of vector registers. Each thread may process k bits of input per round. The numbers N and k may be 32/50 or 25/64 for example.

A single software instruction may invoke the Keccak hardware acceleration unit 802 to perform multiple rounds (1, 2, 4, etc.) and (if invoked for multiple rounds) the Keccak hardware acceleration unit 802 may comprise an incrementer 804 to count the rounds. The count value may be output either explicitly (e.g., when the permuted outputs comprise a full bus width of bits) or embedded in unused bits of the permuted state.

The mechanisms disclosed herein may be implemented in and/or by computing devices utilizing one or more graphic processing unit (GPU) and/or general purpose data processor (e.g., a ‘central processing’ unit or CPU). For example, embodiments of hardware acceleration units comprising a plurality of hardware quarter round units may be implemented as part of a GPU or cooperatively with one or more GPU (e.g., in a CPU, arithmetic logic unit, or neural network hardware accelerator. Exemplary architectures will now be described that may be configured to implement the mechanisms disclosed herein.

By way of example, each streaming multiprocessor 1002 in the computing platforms described below may comprise one or more hardware acceleration units in accordance with the embodiments described herein.

The following description may use certain acronyms and abbreviations as follows:
“DPC” refers to a “data processing cluster”;
“GPC” refers to a “general processing cluster”;
“I/O” refers to a “input/output”;
“L1 cache” refers to “level one cache”;
“L2 cache” refers to “level two cache”;
“LSU” refers to a “load/store unit”;
“MMU” refers to a “memory management unit”;
“MPC” refers to an “M-pipe controller”;
“PPU” refers to a “parallel processing unit”;
“PROP” refers to a “pre-raster operations unit”;
“ROP” refers to a “raster operations”;
“SFU” refers to a “special function unit”;
“SM” refers to a “streaming multiprocessor”;
“Viewport SCC” refers to “viewport scale, cull, and clip”;
“WDX” refers to a “work distribution crossbar”; and
“XBar” refers to a “crossbar”.

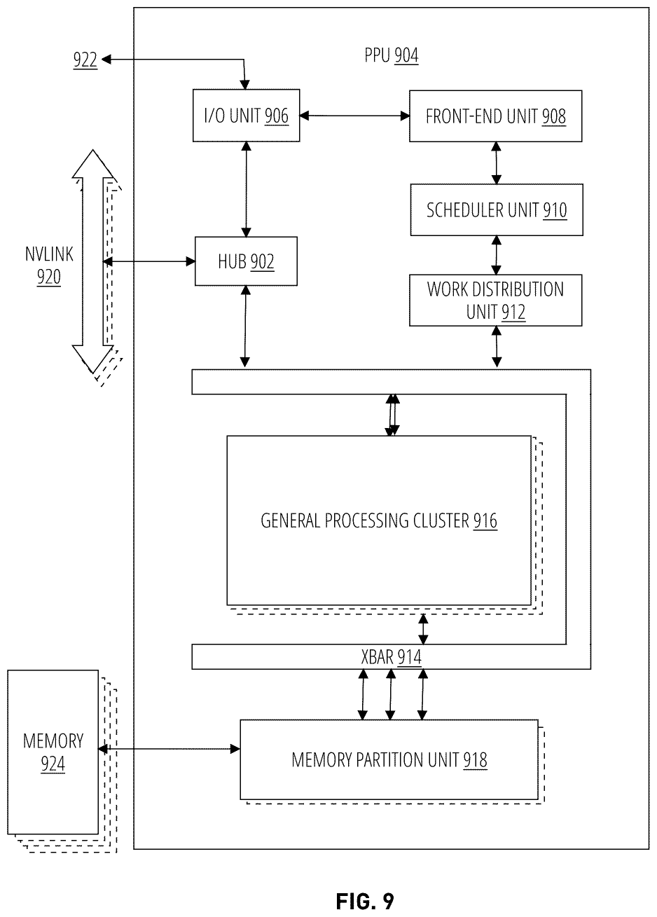

FIG. 9 depicts a parallel processing unit 904, in accordance with an embodiment. In an embodiment, the parallel processing unit 904 is a multi-threaded processor that is implemented on one or more integrated circuit devices. The parallel processing unit 904 is a latency hiding architecture designed to process many threads in parallel. A thread (e.g., a thread of execution) is an instantiation of a set of instructions configured to be executed by the parallel processing unit 904. In an embodiment, the parallel processing unit 904 is a graphics processing unit (GPU) configured to implement a graphics rendering pipeline for processing three-dimensional (3D) graphics data in order to generate two-dimensional (2D) image data for display on a display device such as a liquid crystal display (LCD) device. In other embodiments, the parallel processing unit 904 may be utilized for performing general-purpose computations. While one exemplary parallel processor is provided herein for illustrative purposes, it should be strongly noted that such processor is set forth for illustrative purposes only, and that any processor may be employed to supplement and/or substitute for the same.

One or more parallel processing unit 904 modules may be configured to accelerate thousands of High Performance Computing (HPC), data center, and machine learning applications. The parallel processing unit 904 may be configured to accelerate numerous deep learning systems and applications including autonomous vehicle platforms, deep learning, high-accuracy speech, image, and text recognition systems, intelligent video analytics, molecular simulations, drug discovery, disease diagnosis, weather forecasting, big data analytics, astronomy, molecular dynamics simulation, financial modeling, robotics, factory automation, real-time language translation, online search optimizations, and personalized user recommendations, and the like.

As shown in FIG. 9, the parallel processing unit 904 includes an I/O unit 906, a front-end unit 908, a scheduler unit 910, a work distribution unit 912, a hub 902, a crossbar 914, one or more general processing cluster 916 modules, and one or more memory partition unit 918 modules. The parallel processing unit 904 may be connected to a host processor or other parallel processing unit 904 modules via one or more high-speed NVLink 920 interconnects. The parallel processing unit 904 may be connected to a host processor or other peripheral devices via an interconnect 922. The parallel processing unit 904 may also be connected to a local memory comprising a number of memory 924 devices. In an embodiment, the local memory may comprise a number of dynamic random access memory (DRAM) devices. The DRAM devices may be configured as a high-bandwidth memory (HBM) subsystem, with multiple DRAM dies stacked within each device. The memory 924 may comprise logic to configure the parallel processing unit 904 to carry out aspects of the techniques disclosed herein.

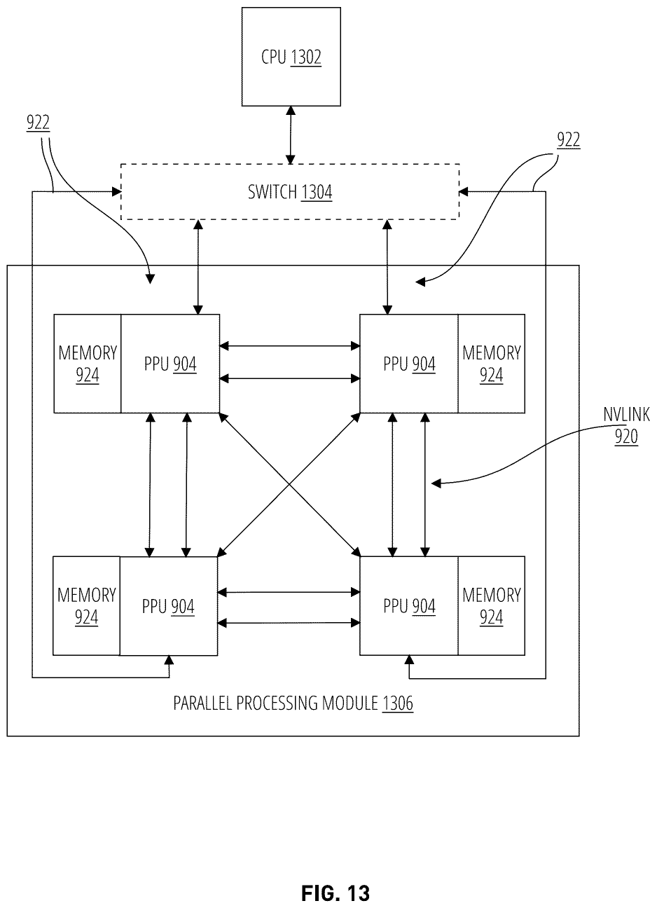

The NVLink 920 interconnect enables systems to scale and include one or more parallel processing unit 904 modules combined with one or more CPUs, supports cache coherence between the parallel processing unit 904 modules and CPUs, and CPU mastering. Data and/or commands may be transmitted by the NVLink 920 through the hub 902 to/from other units of the parallel processing unit 904 such as one or more copy engines, a video encoder, a video decoder, a power management unit, etc. (not explicitly shown). The NVLink 920 is described in more detail in conjunction with FIG. 13.

The I/O unit 906 is configured to transmit and receive communications (e.g., commands, data, etc.) from a host processor (not shown) over the interconnect 922. The I/O unit 906 may communicate with the host processor directly via the interconnect 922 or through one or more intermediate devices such as a memory bridge. In an embodiment, the I/O unit 906 may communicate with one or more other processors, such as one or more parallel processing unit 904 modules via the interconnect 922. In an embodiment, the I/O unit 906 implements a Peripheral Component Interconnect Express (PCIe) interface for communications over a PCIe bus and the interconnect 922 is a PCIe bus. In alternative embodiments, the I/O unit 906 may implement other types of well-known interfaces for communicating with external devices.

The I/O unit 906 decodes packets received via the interconnect 922. In an embodiment, the packets represent commands configured to cause the parallel processing unit 904 to perform various operations. The I/O unit 906 transmits the decoded commands to various other units of the parallel processing unit 904 as the commands may specify. For example, some commands may be transmitted to the front-end unit 908. Other commands may be transmitted to the hub 902 or other units of the parallel processing unit 904 such as one or more copy engines, a video encoder, a video decoder, a power management unit, etc. (not explicitly shown). In other words, the I/O unit 906 is configured to route communications between and among the various logical units of the parallel processing unit 904.

In an embodiment, a program executed by the host processor encodes a command stream in a buffer that provides workloads to the parallel processing unit 904 for processing. A workload may comprise several instructions and data to be processed by those instructions. The buffer is a region in a memory that is accessible (e.g., read/write) by both the host processor and the parallel processing unit 904. For example, the I/O unit 906 may be configured to access the buffer in a system memory connected to the interconnect 922 via memory requests transmitted over the interconnect 922. In an embodiment, the host processor writes the command stream to the buffer and then transmits a pointer to the start of the command stream to the parallel processing unit 904. The front-end unit 908 receives pointers to one or more command streams. The front-end unit 908 manages the one or more streams, reading commands from the streams and forwarding commands to the various units of the parallel processing unit 904.

The front-end unit 908 is coupled to a scheduler unit 910 that configures the various general processing cluster 916 modules to process tasks defined by the one or more streams. The scheduler unit 910 is configured to track state information related to the various tasks managed by the scheduler unit 910. The state may indicate which general processing cluster 916 a task is assigned to, whether the task is active or inactive, a priority level associated with the task, and so forth. The scheduler unit 910 manages the execution of a plurality of tasks on the one or more general processing cluster 916 modules.

The scheduler unit 910 is coupled to a work distribution unit 912 that is configured to dispatch tasks for execution on the general processing cluster 916 modules. The work distribution unit 912 may track a number of scheduled tasks received from the scheduler unit 910. In an embodiment, the work distribution unit 912 manages a pending task pool and an active task pool for each of the general processing cluster 916 modules. The pending task pool may comprise a number of slots (e.g., 32 slots) that contain tasks assigned to be processed by a particular general processing cluster 916. The active task pool may comprise a number of slots (e.g., 4 slots) for tasks that are actively being processed by the general processing cluster 916 modules. As a general processing cluster 916 finishes the execution of a task, that task is evicted from the active task pool for the general processing cluster 916 and one of the other tasks from the pending task pool is selected and scheduled for execution on the general processing cluster 916. If an active task has been idle on the general processing cluster 916, such as while waiting for a data dependency to be resolved, then the active task may be evicted from the general processing cluster 916 and returned to the pending task pool while another task in the pending task pool is selected and scheduled for execution on the general processing cluster 916.

The work distribution unit 912 communicates with the one or more general processing cluster 916 modules via crossbar 914. The crossbar 914 is an interconnect network that couples many of the units of the parallel processing unit 904 to other units of the parallel processing unit 904. For example, the crossbar 914 may be configured to couple the work distribution unit 912 to a particular general processing cluster 916. Although not shown explicitly, one or more other units of the parallel processing unit 904 may also be connected to the crossbar 914 via the hub 902.

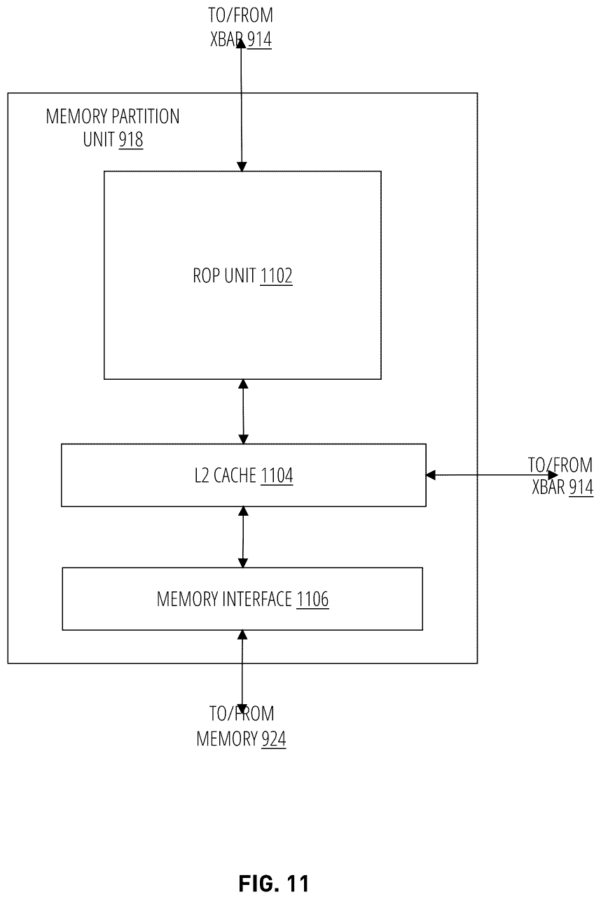

The tasks are managed by the scheduler unit 910 and dispatched to a general processing cluster 916 by the work distribution unit 912. The general processing cluster 916 is configured to process the task and generate results. The results may be consumed by other tasks within the general processing cluster 916, routed to a different general processing cluster 916 via the crossbar 914, or stored in the memory 924. The results can be written to the memory 924 via the memory partition unit 918 modules, which implement a memory interface for reading and writing data to/from the memory 924. The results can be transmitted to another parallel processing unit 904 or CPU via the NVLink 920. In an embodiment, the parallel processing unit 904 includes a number U of memory partition unit 918 modules that is equal to the number of separate and distinct memory 924 devices coupled to the parallel processing unit 904. A memory partition unit 918 will be described in more detail below in conjunction with FIG. 11.

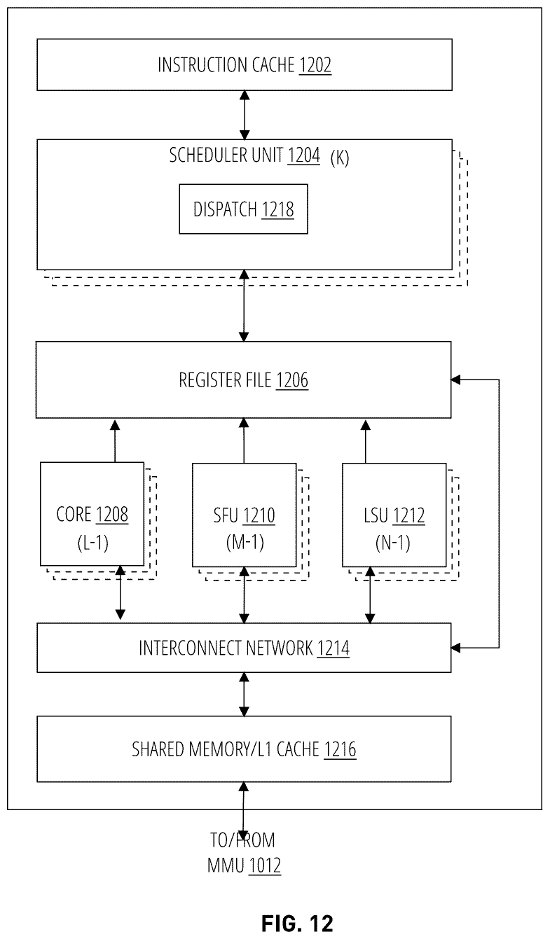

In an embodiment, a host processor executes a driver kernel that implements an application programming interface (API) that enables one or more applications executing on the host processor to schedule operations for execution on the parallel processing unit 904. In an embodiment, multiple compute applications are simultaneously executed by the parallel processing unit 904 and the parallel processing unit 904 provides isolation, quality of service (QoS), and independent address spaces for the multiple compute applications. An application may generate instructions (e.g., API calls) that cause the driver kernel to generate one or more tasks for execution by the parallel processing unit 904. The driver kernel outputs tasks to one or more streams being processed by the parallel processing unit 904. Each task may comprise one or more groups of related threads, referred to herein as a warp. In an embodiment, a warp comprises 32 related threads that may be executed in parallel. Cooperating threads may refer to a plurality of threads including instructions to perform the task and that may exchange data through shared memory. Threads and cooperating threads are described in more detail in conjunction with FIG. 12.

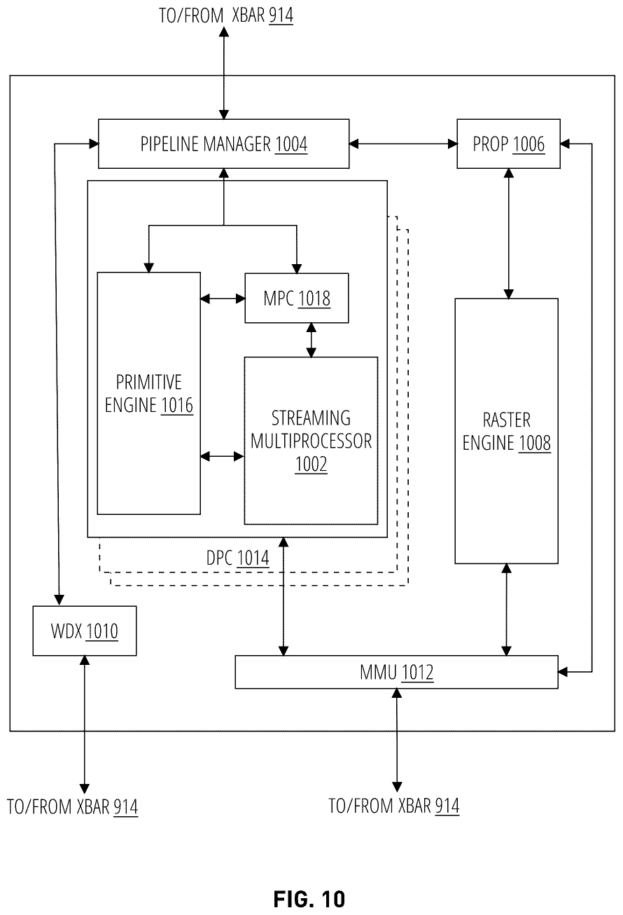

FIG. 10 depicts a general processing cluster 916 of the parallel processing unit 904 of FIG. 9, in accordance with an embodiment. As shown in FIG. 10, each general processing cluster 916 includes a number of hardware units for processing tasks. In an embodiment, each general processing cluster 916 includes a pipeline manager 1004, a pre-raster operations unit 1006, a raster engine 1008, a work distribution crossbar 1010, a memory management unit 1012, and one or more data processing cluster 1014. It will be appreciated that the general processing cluster 916 of FIG. 10 may include other hardware units in lieu of or in addition to the units shown in FIG. 10.

In an embodiment, the operation of the general processing cluster 916 is controlled by the pipeline manager 1004. The pipeline manager 1004 manages the configuration of the one or more data processing cluster 1014 modules for processing tasks allocated to the general processing cluster 916. In an embodiment, the pipeline manager 1004 may configure at least one of the one or more data processing cluster 1014 modules to implement at least a portion of a graphics rendering pipeline. For example, a data processing cluster 1014 may be configured to execute a vertex shader program on the programmable streaming multiprocessor 1002. The pipeline manager 1004 may also be configured to route packets received from the work distribution unit 912 to the appropriate logical units within the general processing cluster 916. For example, some packets may be routed to fixed function hardware units in the pre-raster operations unit 1006 and/or raster engine 1008 while other packets may be routed to the data processing cluster 1014 modules for processing by the primitive engine 1016 or the streaming multiprocessor 1002. In an embodiment, the pipeline manager 1004 may configure at least one of the one or more data processing cluster 1014 modules to implement a neural network model and/or a computing pipeline.

The pre-raster operations unit 1006 is configured to route data generated by the raster engine 1008 and the data processing cluster 1014 modules to a Raster Operations (ROP) unit, described in more detail in conjunction with FIG. 11. The pre-raster operations unit 1006 may also be configured to perform optimizations for color blending, organize pixel data, perform address translations, and the like.

The raster engine 1008 includes a number of fixed function hardware units configured to perform various raster operations. In an embodiment, the raster engine 1008 includes a setup engine, a coarse raster engine, a culling engine, a clipping engine, a fine raster engine, and a tile coalescing engine. The setup engine receives transformed vertices and generates plane equations associated with the geometric primitive defined by the vertices. The plane equations are transmitted to the coarse raster engine to generate coverage information (e.g., an x, y coverage mask for a tile) for the primitive. The output of the coarse raster engine is transmitted to the culling engine where fragments associated with the primitive that fail a z-test are culled, and transmitted to a clipping engine where fragments lying outside a viewing frustum are clipped. Those fragments that survive clipping and culling may be passed to the fine raster engine to generate attributes for the pixel fragments based on the plane equations generated by the setup engine. The output of the raster engine 1008 comprises fragments to be processed, for example, by a fragment shader implemented within a data processing cluster 1014.

Each data processing cluster 1014 included in the general processing cluster 916 includes an M-pipe controller 1018, a primitive engine 1016, and one or more streaming multiprocessor 1002 modules. The M-pipe controller 1018 controls the operation of the data processing cluster 1014, routing packets received from the pipeline manager 1004 to the appropriate units in the data processing cluster 1014. For example, packets associated with a vertex may be routed to the primitive engine 1016, which is configured to fetch vertex attributes associated with the vertex from the memory 924. In contrast, packets associated with a shader program may be transmitted to the streaming multiprocessor 1002.

The streaming multiprocessor 1002 comprises a programmable streaming processor that is configured to process tasks represented by a number of threads. Each streaming multiprocessor 1002 is multi-threaded and configured to execute a plurality of threads (e.g., 32 threads) from a particular group of threads concurrently. In an embodiment, the streaming multiprocessor 1002 implements a Single-Instruction, Multiple-Data (SIMD) architecture where each thread in a group of threads (e.g., a warp) is configured to process a different set of data based on the same set of instructions. All threads in the group of threads execute the same instructions. In another embodiment, the streaming multiprocessor 1002 implements a Single-Instruction, Multiple Thread (SIMT) architecture where each thread in a group of threads is configured to process a different set of data based on the same set of instructions, but where individual threads in the group of threads are allowed to diverge during execution. In an embodiment, a program counter, call stack, and execution state is maintained for each warp, enabling concurrency between warps and serial execution within warps when threads within the warp diverge. In another embodiment, a program counter, call stack, and execution state is maintained for each individual thread, enabling equal concurrency between all threads, within and between warps. When execution state is maintained for each individual thread, threads executing the same instructions may be converged and executed in parallel for maximum efficiency. The streaming multiprocessor 1002 will be described in more detail below in conjunction with FIG. 12.

The memory management unit 1012 provides an interface between the general processing cluster 916 and the memory partition unit 918. The memory management unit 1012 may provide translation of virtual addresses into physical addresses, memory protection, and arbitration of memory requests. In an embodiment, the memory management unit 1012 provides one or more translation lookaside buffers (TLBs) for performing translation of virtual addresses into physical addresses in the memory 924.

FIG. 11 depicts a memory partition unit 918 of the parallel processing unit 904 of FIG. 9, in accordance with an embodiment. As shown in FIG. 11, the memory partition unit 918 includes a raster operations unit 1102, a level two cache 1104, and a memory interface 1106. The memory interface 1106 is coupled to the memory 924. Memory interface 1106 may implement 32, 64, 128, 1024-bit data buses, or the like, for high-speed data transfer. In an embodiment, the parallel processing unit 904 incorporates U memory interface 1106 modules, one memory interface 1106 per pair of memory partition unit 918 modules, where each pair of memory partition unit 918 modules is connected to a corresponding memory 924 device. For example, parallel processing unit 904 may be connected to up to Y memory 924 devices, such as high bandwidth memory stacks or graphics double-data-rate, version 5, synchronous dynamic random access memory, or other types of persistent storage.

In an embodiment, the memory interface 1106 implements an HBM2 memory interface and Y equals half U. In an embodiment, the HBM2 memory stacks are located on the same physical package as the parallel processing unit 904, providing substantial power and area savings compared with conventionalGDDR5 SDRAM systems. In an embodiment, each HBM2 stack includes four memory dies and Y equals 4, with HBM2 stack including two 128-bit channels per die for a total of 8 channels and a data bus width of 1024 bits.

In an embodiment, the memory 924 supports Single-Error Correcting Double-Error Detecting (SECDED) Error Correction Code (ECC) to protect data. ECC provides higher reliability for compute applications that are sensitive to data corruption. Reliability is especially important in large-scale cluster computing environments where parallel processing unit 904 modules process very large datasets and/or run applications for extended periods.

In an embodiment, the parallel processing unit 904 implements a multi-level memory hierarchy. In an embodiment, the memory partition unit 918 supports a unified memory to provide a single unified virtual address space for CPU and parallel processing unit 904 memory, enabling data sharing between virtual memory systems. In an embodiment the frequency of accesses by a parallel processing unit 904 to memory located on other processors is traced to ensure that memory pages are moved to the physical memory of the parallel processing unit 904 that is accessing the pages more frequently. In an embodiment, the NVLink 920 supports address translation services allowing the parallel processing unit 904 to directly access a CPU's page tables and providing full access to CPU memory by the parallel processing unit 904.

In an embodiment, copy engines transfer data between multiple parallel processing unit 904 modules or between parallel processing unit 904 modules and CPUs. The copy engines can generate page faults for addresses that are not mapped into the page tables. The memory partition unit 918 can then service the page faults, mapping the addresses into the page table, after which the copy engine can perform the transfer. In a conventional system, memory is pinned (e.g., non-pageable) for multiple copy engine operations between multiple processors, substantially reducing the available memory. With hardware page faulting, addresses can be passed to the copy engines without worrying if the memory pages are resident, and the copy process is transparent.

Data from the memory 924 or other system memory may be fetched by the memory partition unit 918 and stored in the level two cache 1104, which is located on-chip and is shared between the various general processing cluster 916 modules. As shown, each memory partition unit 918 includes a portion of the level two cache 1104 associated with a corresponding memory 924 device. Lower level caches may then be implemented in various units within the general processing cluster 916 modules. For example, each of the streaming multiprocessor 1002 modules may implement an L1 cache. The L1 cache is private memory that is dedicated to a particular streaming multiprocessor 1002. Data from the level two cache 1104 may be fetched and stored in each of the L1 caches for processing in the functional units of the streaming multiprocessor 1002 modules. The level two cache 1104 is coupled to the memory interface 1106 and the crossbar 914.

The raster operations unit 1102 performs graphics raster operations related to pixel color, such as color compression, pixel blending, and the like. The raster operations unit 1102 also implements depth testing in conjunction with the raster engine 1008, receiving a depth for a sample location associated with a pixel fragment from the culling engine of the raster engine 1008. The depth is tested against a corresponding depth in a depth buffer for a sample location associated with the fragment. If the fragment passes the depth test for the sample location, then the raster operations unit 1102 updates the depth buffer and transmits a result of the depth test to the raster engine 1008. It will be appreciated that the number of partition memory partition unit 918 modules may be different than the number of general processing cluster 916 modules and, therefore, each raster operations unit 1102 may be coupled to each of the general processing cluster 916 modules. The raster operations unit 1102 tracks packets received from the different general processing cluster 916 modules and determines which general processing cluster 1 that a result generated by the raster operations unit 1102 is routed to through the crossbar 914. Although the raster operations unit 1102 is included within the memory partition unit 918 in FIG. 11, in other embodiment, the raster operations unit 1102 may be outside of the memory partition unit 918. For example, the raster operations unit 1102 may reside in the general processing cluster 916 or another unit.

FIG. 12 illustrates the streaming multiprocessor 1002 of FIG. 10, in accordance with an embodiment. As shown in FIG. 12, the streaming multiprocessor 1002 includes an instruction cache 1202, one or more scheduler unit 1204 modules (e.g., such as scheduler unit 910), a register file 1206, one or more processing core 1208 modules, one or more special function unit 1210 modules, one or more load/store unit 1212 modules, an interconnect network 1214, and a shared memory/L1 cache 1216.

As described above, the work distribution unit 912 dispatches tasks for execution on the general processing cluster 916 modules of the parallel processing unit 904. The tasks are allocated to a particular data processing cluster 1014 within a general processing cluster 916 and, if the task is associated with a shader program, the task may be allocated to a streaming multiprocessor 1002. The scheduler unit 910 receives the tasks from the work distribution unit 912 and manages instruction scheduling for one or more thread blocks assigned to the streaming multiprocessor 1002. The scheduler unit 1204 schedules thread blocks for execution as warps of parallel threads, where each thread block is allocated at least one warp. In an embodiment, each warp executes 32 threads. The scheduler unit 1204 may manage a plurality of different thread blocks, allocating the warps to the different thread blocks and then dispatching instructions from the plurality of different cooperative groups to the various functional units (e.g., core 1208 modules, special function unit 1210 modules, and load/store unit 1212 modules) during each clock cycle.

Cooperative Groups is a programming model for organizing groups of communicating threads that allows developers to express the granularity at which threads are communicating, enabling the expression of richer, more efficient parallel decompositions. Cooperative launch APIs support synchronization amongst thread blocks for the execution of parallel algorithms. Conventional programming models provide a single, simple construct for synchronizing cooperating threads: a barrier across all threads of a thread block (e.g., the syncthreads ( ) function). However, programmers would often like to define groups of threads at smaller than thread block granularities and synchronize within the defined groups to enable greater performance, design flexibility, and software reuse in the form of collective group-wide function interfaces.

Cooperative Groups enables programmers to define groups of threads explicitly at sub-block (e.g., as small as a single thread) and multi-block granularities, and to perform collective operations such as synchronization on the threads in a cooperative group. The programming model supports clean composition across software boundaries, so that libraries and utility functions can synchronize safely within their local context without having to make assumptions about convergence. Cooperative Groups primitives enable new patterns of cooperative parallelism, including producer-consumer parallelism, opportunistic parallelism, and global synchronization across an entire grid of thread blocks.

A dispatch 1218 unit is configured within the scheduler unit 1204 to transmit instructions to one or more of the functional units. In one embodiment, the scheduler unit 1204 includes two dispatch 1218 units that enable two different instructions from the same warp to be dispatched during each clock cycle. In alternative embodiments, each scheduler unit 1204 may include a single dispatch 1218 unit or additional dispatch 1218 units.

Each streaming multiprocessor 1002 includes a register file 1206 that provides a set of registers for the functional units of the streaming multiprocessor 1002. In an embodiment, the register file 1206 is divided between each of the functional units such that each functional unit is allocated a dedicated portion of the register file 1206. In another embodiment, the register file 1206 is divided between the different warps being executed by the streaming multiprocessor 1002. The register file 1206 provides temporary storage for operands connected to the data paths of the functional units.

Each streaming multiprocessor 1002 comprises L processing core 1208 modules. In an embodiment, the streaming multiprocessor 1002 includes a large number (e.g., 128, etc.) of distinct processing core 1208 modules. Each core 1208 may include a fully-pipelined, single-precision, double-precision, and/or mixed precision processing unit that includes a floating point arithmetic logic unit and an integer arithmetic logic unit. In an embodiment, the floating point arithmetic logic units implement the IEEE 754-2008 standard for floating point arithmetic. In an embodiment, the core 1208 modules include 64 single-precision (32-bit) floating point cores, 64 integer cores, 32 double-precision (64-bit) floating point cores, and 8 tensor cores.

Tensor cores configured to perform matrix operations, and, in an embodiment, one or more tensor cores are included in the core 1208 modules. In particular, the tensor cores are configured to perform deep learning matrix arithmetic, such as convolution operations for neural network training and inferencing. In an embodiment, each tensor core operates on a 4×4 matrix and performs a matrix multiply and accumulate operation D=A′B+C, where A, B, C, and D are 4×4 matrices.

In an embodiment, the matrix multiply inputs A and B are 16-bit floating point matrices, while the accumulation matrices C and D may be 16-bit floating point or 32-bit floating point matrices. Tensor Cores operate on 16-bit floating point input data with 32-bit floating point accumulation. The 16-bit floating point multiply requires 64 operations and results in a full precision product that is then accumulated using 32-bit floating point addition with the other intermediate products for a 4×4×4 matrix multiply. In practice, Tensor Cores are used to perform much larger two-dimensional or higher dimensional matrix operations, built up from these smaller elements. An API, such as CUDA 9 C++ API, exposes specialized matrix load, matrix multiply and accumulate, and matrix store operations to efficiently use Tensor Cores from a CUDA-C++ program. At the CUDA level, the warp-level interface assumes 16×16 size matrices spanning all 32 threads of the warp.

Each streaming multiprocessor 1002 also comprises M special function unit 1210 modules that perform special functions (e.g., attribute evaluation, reciprocal square root, and the like). In an embodiment, the special function unit 1210 modules may include a tree traversal unit configured to traverse a hierarchical tree data structure. In an embodiment, the special function unit 1210 modules may include texture unit configured to perform texture map filtering operations. In an embodiment, the texture units are configured to load texture maps (e.g., a 2D array of texels) from the memory 924 and sample the texture maps to produce sampled texture values for use in shader programs executed by the streaming multiprocessor 1002. In an embodiment, the texture maps are stored in the shared memory/L1 cache 1216. The texture units implement texture operations such as filtering operations using mip-maps (e.g., texture maps of varying levels of detail). In an embodiment, each streaming multiprocessor 1002 includes two texture units.

Each streaming multiprocessor 1002 also comprises N load/store unit 1212 modules that implement load and store operations between the shared memory/L1 cache 1216 and the register file 1206. Each streaming multiprocessor 1002 includes an interconnect network 1214 that connects each of the functional units to the register file 1206 and the load/store unit 1212 to the register file 1206 and shared memory/L1 cache 1216. In an embodiment, the interconnect network 1214 is a crossbar that can be configured to connect any of the functional units to any of the registers in the register file 1206 and connect the load/store unit 1212 modules to the register file 1206 and memory locations in shared memory/L1 cache 1216.

The shared memory/L1 cache 1216 is an array of on-chip memory that allows for data storage and communication between the streaming multiprocessor 1002 and the primitive engine 1016 and between threads in the streaming multiprocessor 1002. In an embodiment, the shared memory/L1 cache 1216 comprises 128 KB of storage capacity and is in the path from the streaming multiprocessor 1002 to the memory partition unit 918. The shared memory/L1 cache 1216 can be used to cache reads and writes. One or more of the shared memory/L1 cache 1216, level two cache 1104, and memory 924are backing stores.

Combining data cache and shared memory functionality into a single memory block provides the best overall performance for both types of memory accesses. The capacity is usable as a cache by programs that do not use shared memory. For example, if shared memory is configured to use half of the capacity, texture and load/store operations can use the remaining capacity. Integration within the shared memory/L1 cache 1216 enables the shared memory/L1 cache 1216 to function as a high-throughput conduit for streaming data while simultaneously providing high-bandwidth and low-latency access to frequently reused data.

When configured for general purpose parallel computation, a simpler configuration can be used compared with graphics processing. Specifically, the fixed function graphics processing units shown in FIG. 9, are bypassed, creating a much simpler programming model. In the general purpose parallel computation configuration, the work distribution unit 912 assigns and distributes blocks of threads directly to the data processing cluster 1014 modules. The threads in a block execute the same program, using a unique thread ID in the calculation to ensure each thread generates unique results, using the streaming multiprocessor 1002 to execute the program and perform calculations, shared memory/L1 cache 1216 to communicate between threads, and the load/store unit 1212 to read and write global memory through the shared memory/L1 cache 1216 and the memory partition unit 918. When configured for general purpose parallel computation, the streaming multiprocessor 1002 can also write commands that the scheduler unit 910 can use to launch new work on the data processing cluster 1014 modules.

The parallel processing unit 904 may be included in a desktop computer, a laptop computer, a tablet computer, servers, supercomputers, a smart-phone (e.g., a wireless, hand-held device), personal digital assistant (PDA), a digital camera, a vehicle, a head mounted display, a hand-held electronic device, and the like. In an embodiment, the parallel processing unit 904 is embodied on a single semiconductor substrate. In another embodiment, the parallel processing unit 904 is included in a system-on-a-chip (SoC) along with one or more other devices such as additional parallel processing unit 904 modules, the memory 924, a reduced instruction set computer (RISC) CPU, a memory management unit (MMU), a digital-to-analog converter (DAC), and the like.

In an embodiment, the parallel processing unit 904 may be included on a graphics card that includes one or more memory devices. The graphics card may be configured to interface with a PCIe slot on a motherboard of a desktop computer. In yet another embodiment, the parallel processing unit 904 may be an integrated graphics processing unit (iGPU) or parallel processor included in the chipset of the motherboard.

Systems with multiple GPUs and CPUs are used in a variety of industries as developers expose and leverage more parallelism in applications such as artificial intelligence computing. High-performance GPU-accelerated systems with tens to many thousands of compute nodes are deployed in data centers, research facilities, and supercomputers to solve ever larger problems. As the number of processing devices within the high-performance systems increases, the communication and data transfer mechanisms need to scale to support the increased bandwidth.

FIG. 13 is a conceptual diagram of a processing system implemented using the parallel processing unit 904 of FIG. 9, in accordance with an embodiment. The processing system includes a central processing unit 1302, a switch 1304, and multiple parallel processing unit 904 modules each and respective memory 924 modules. The switch 1304 is depicted with dashed lines, indicating that it is optional in some embodiments.

The NVLink 920 provides high-speed communication links between each of the parallel processing unit 904 modules. Although a particular number of NVLink 920 and interconnect 922 connections are illustrated in FIG. 13, the number of connections to each parallel processing unit 904 and the central processing unit 1302 may vary. The switch 1304 interfaces between the interconnect 922 and the central processing unit 1302. The parallel processing unit 904 modules, memory 924 modules, and NVLink 920 connections may be situated on a single semiconductor platform to form a parallel processing module 1306. In an embodiment, the switch 1304 supports two or more protocols to interface between various different connections and/or links.

In another embodiment (not shown), the NVLink 920 provides one or more high-speed communication links between each of the parallel processing unit modules (parallel processing unit 904, parallel processing unit 904, parallel processing unit 904, and parallel processing unit 904) and the central processing unit 1302 and the switch 1304 (when present) interfaces between the interconnect 922 and each of the parallel processing unit modules. The parallel processing unit modules, memory 924 modules, and interconnect 922 may be situated on a single semiconductor platform to form a parallel processing module 1306. In yet another embodiment (not shown), the interconnect 922 provides one or more communication links between each of the parallel processing unit modules and the central processing unit 1302 and the switch 1304 interfaces between each of the parallel processing unit modules using the NVLink 920 to provide one or more high-speed communication links between the parallel processing unit modules. In another embodiment (not shown), the NVLink 920 provides one or more high-speed communication links between the parallel processing unit modules and the central processing unit 1302 through the switch 1304. In yet another embodiment (not shown), the interconnect 922 provides one or more communication links between each of the parallel processing unit modules directly. One or more of the NVLink 920 high-speed communication links may be implemented as a physical NVLink interconnect or either an on-chip or on-die interconnect using the same protocol as the NVLink 920.

In the context of the present description, a single semiconductor platform may refer to a sole unitary semiconductor-based integrated circuit fabricated on a die or chip. It should be noted that the term single semiconductor platform may also refer to multi-chip modules with increased connectivity which simulate on-chip operation and make substantial improvements over utilizing a conventional bus implementation. Of course, the various circuits or devices may also be situated separately or in various combinations of semiconductor platforms per the desires of the user. Alternately, the parallel processing module 1306 may be implemented as a circuit board substrate and each of the parallel processing unit modules and/or memory 924 modules may be packaged devices. In an embodiment, the central processing unit 1302, switch 1304, and the parallel processing module 1306 are situated on a single semiconductor platform.

In an embodiment, each parallel processing unit module includes six NVLink 920 interfaces (as shown in FIG. 13, five NVLink 920 interfaces are included for each parallel processing unit module). The NVLink 920 may be operated exclusively for PPU-to-PPU communication as shown in FIG. 13, or some combination of PPU-to-PPU and PPU-to-CPU, when the central processing unit 1302 also includes one or more NVLink 920 interfaces.

In an embodiment, the NVLink 920 allows direct load/store/atomic access from the central processing unit 1302 to each parallel processing unit module's memory 924. In an embodiment, the NVLink 920 supports coherency operations, allowing data read from the memory 924 modules to be stored in the cache hierarchy of the central processing unit 1302, reducing cache access latency for the central processing unit 1302. In an embodiment, the NVLink 920 includes support for Address Translation Services (ATS), enabling the parallel processing unit module to directly access page tables within the central processing unit 1302. One or more of the NVLink 920 may also be configured to operate in a low-power mode.

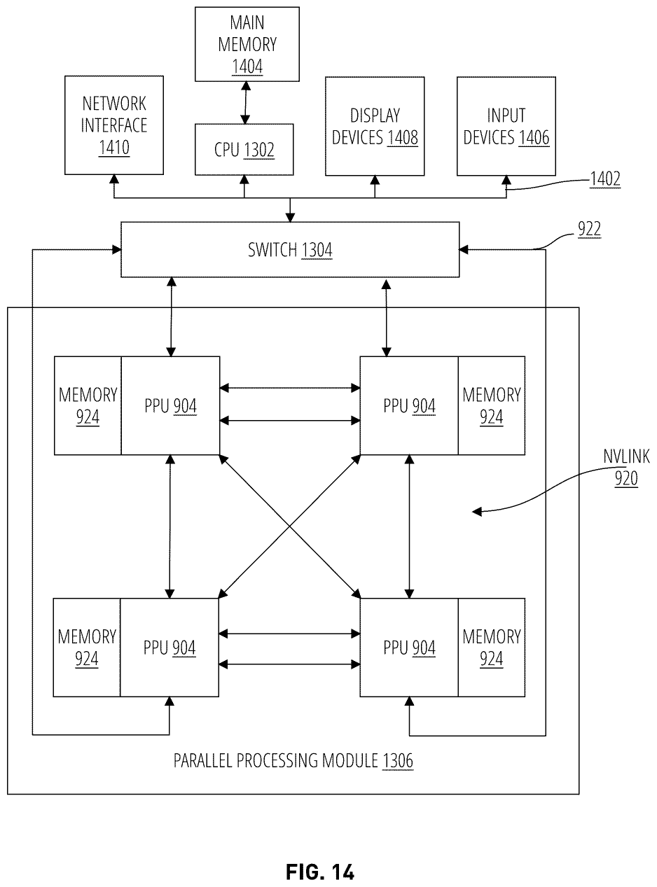

FIG. 14 depicts an exemplary processing system in which the various architecture and/or functionality of the various previous embodiments may be implemented. As shown, an exemplary processing system is provided including at least one central processing unit 1302 that is connected to a communications bus 1402. The communication communications bus 1402 may be implemented using any suitable protocol, such as PCI (Peripheral Component Interconnect), PCI-Express, AGP (Accelerated Graphics Port), HyperTransport, or any other bus or point-to-point communication protocol(s). The exemplary processing system also includes a main memory 1404. Control logic (software) and data are stored in the main memory 1404 which may take the form of random access memory (RAM).

The exemplary processing system also includes input devices 1406, the parallel processing module 1306, and display devices 1408, e.g. a conventional CRT (cathode ray tube), LCD (liquid crystal display), LED (light emitting diode), plasma display or the like. User input may be received from the input devices 1406, e.g., keyboard, mouse, touchpad, microphone, and the like. Each of the foregoing modules and/or devices may even be situated on a single semiconductor platform to form the exemplary processing system. Alternately, the various modules may also be situated separately or in various combinations of semiconductor platforms per the desires of the user.

Further, the exemplary processing system may be coupled to a network (e.g., a telecommunications network, local area network (LAN), wireless network, wide area network (WAN) such as the Internet, peer-to-peer network, cable network, or the like) through a network interface 1410 for communication purposes.

The exemplary processing system may also include a secondary storage (not shown). The secondary storage includes, for example, a hard disk drive and/or a removable storage drive, representing a floppy disk drive, a magnetic tape drive, a compact disk drive, digital versatile disk (DVD) drive, recording device, universal serial bus (USB) flash memory. The removable storage drive reads from and/or writes to a removable storage unit in a well-known manner.

Computer programs, or computer control logic algorithms, may be stored in the main memory 1404 and/or the secondary storage. Such computer programs, when executed, enable the exemplary processing system to perform various functions. The main memory 1404, the storage, and/or any other storage are possible examples of computer-readable media.

The architecture and/or functionality of the various previous figures may be implemented in the context of a general computer system, a circuit board system, a game console system dedicated for entertainment purposes, an application-specific system, and/or any other desired system. For example, the exemplary processing system may take the form of a desktop computer, a laptop computer, a tablet computer, servers, supercomputers, a smart-phone (e.g., a wireless, hand-held device), personal digital assistant (PDA), a digital camera, a vehicle, a head mounted display, a hand-held electronic device, a mobile phone device, a television, workstation, game consoles, embedded system, and/or any other type of logic.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

### LISTING OF DRAWING ELEMENTS

102 neural network
104 training logic
106 training set
108 random number generator
302 hardware acceleration unit
304 serializer
502 hardware quarter round unit
602 multiplexers
702 theta circuit
704 rho circuit
706 pi circuit
708 chi circuit
710 iota circuit
802 Keccak hardware acceleration unit
804 incrementer
902 hub
904 parallel processing unit
906 I/O unit
908 front-end unit
910 scheduler unit
912 work distribution unit
914 crossbar
916 general processing cluster
918 memory partition unit
920 NVLink
922 interconnect
924 memory
1002 streaming multiprocessor
1004 pipeline manager
1006 pre-raster operations unit
1008 raster engine
1010 work distribution crossbar
1012 memory management unit
1014 data processing cluster
1016 primitive engine
1018 M-pipe controller
1102 raster operations unit
1104 level two cache
1106 memory interface
1202 instruction cache
1204 scheduler unit
1206 register file
1208 core
1210 special function unit
1212 load/store unit
1214 interconnect network
1216 shared memory/L1 cache
1218 dispatch
1302 central processing unit
1304 switch
1306 parallel processing module
1402 communications bus
1404 main memory
1406 input devices
1408 display devices
1410 network interface

Various functional operations described herein may be implemented in logic that is referred to using a noun or noun phrase reflecting said operation or function. For example, an association operation may be carried out by an “associator” or “correlator”. Likewise, switching may be carried out by a “switch”, selection by a “selector”, and so on. “Logic” refers to machine memory circuits and non-transitory machine readable media comprising machine-executable instructions (software and firmware), and/or circuitry (hardware) which by way of its material and/or material-energy configuration comprises control and/or procedural signals, and/or settings and values (such as resistance, impedance, capacitance, inductance, current/voltage ratings, etc.), that may be applied to influence the operation of a device. Magnetic media, electronic circuits, electrical and optical memory (both volatile and nonvolatile), and firmware are examples of logic. Logic specifically excludes pure signals or software per se (however does not exclude machine memories comprising software and thereby forming configurations of matter). Logic symbols in the drawings should be understood to have their ordinary interpretation in the art in terms of functionality and various structures that may be utilized for their implementation, unless otherwise indicated.

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical, such as an electronic circuit). More specifically, this formulation is used to indicate that this structure is arranged to perform the one or more tasks during operation. A structure can be said to be “configured to” perform some task even if the structure is not currently being operated. A “credit distribution circuit configured to distribute credits to a plurality of processor cores” is intended to cover, for example, an integrated circuit that has circuitry that performs this function during operation, even if the integrated circuit in question is not currently being used (e.g., a power supply is not connected to it). Thus, an entity described or recited as “configured to” perform some task refers to something physical, such as a device, circuit, memory storing program instructions executable to implement the task, etc. This phrase is not used herein to refer to something intangible.

The term “configured to” is not intended to mean “configurable to.” An unprogrammed FPGA, for example, would not be considered to be “configured to” perform some specific function, although it may be “configurable to” perform that function after programming.

Reciting in the appended claims that a structure is “configured to” perform one or more tasks is expressly intended not to invoke 35 U.S.C. § 112 (f) for that claim element. Accordingly, claims in this application that do not otherwise include the “means for” [performing a function] construct should not be interpreted under 35 U.S.C § 112 (f).

As used herein, the term “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

As used herein, the phrase “in response to” describes one or more factors that trigger an effect. This phrase does not foreclose the possibility that additional factors may affect or otherwise trigger the effect. That is, an effect may be solely in response to those factors, or may be in response to the specified factors as well as other, unspecified factors. Consider the phrase “perform A in response to B.” This phrase specifies that B is a factor that triggers the performance of A. This phrase does not foreclose that performing A may also be in response to some other factor, such as C. This phrase is also intended to cover an embodiment in which A is performed solely in response to B.

As used herein, the terms “first,” “second,” etc. are used as labels for nouns that they precede, and do not imply any type of ordering (e.g., spatial, temporal, logical, etc.), unless stated otherwise. For example, in a register file having eight registers, the terms “first register” and “second register” can be used to refer to any two of the eight registers, and not, for example, just logical registers 0 and 1.

When used in the claims, the term “or” is used as an inclusive or and not as an exclusive or. For example, the phrase “at least one of x, y, or z” means any one of x, y, and z, as well as any combination thereof.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

Although the terms “step” and/or “block” may be used herein to connote different elements of methods employed, the terms should not be interpreted as implying any particular order among or between various steps herein disclosed unless and except when the order of individual steps is explicitly described.

Having thus described illustrative embodiments in detail, it will be apparent that modifications and variations are possible without departing from the scope of the disclosure as claimed. The scope of inventive subject matter is not limited to the depicted embodiments but is rather set forth in the following Claims.

What is claimed is:

1. A system comprising:
one or more data processors;
a hardware acceleration unit;
a random number generator configured with a cryptographic primitive that, when executed by the one or more processors, operates the hardware acceleration unit to perform at least one ChaCha round.

2. The system of claim 1, wherein the cryptographic primitive operates the hardware acceleration unit to perform at least one ChaCha double round.

3. The system of claim 1, wherein the cryptographic primitive comprises a parameter to set a number of ChaCha rounds for the hardware acceleration unit to perform.

4. The system of claim 1, further comprising:
a neural network; and
training logic configured to apply an output of the random number generator to set a dropout rate for the neural network.

5. The system of claim 1, wherein the random number generator is multithreaded.

6. The system of claim 5, wherein the random number generator is configured to apply thread shuffling to route state information between the ChaCha rounds.

7. The system of claim 5, wherein multiple threads of the random number generator are configured to cooperate to combine results returned from execution of the cryptographic primitive.

8. The system of claim 1, wherein the hardware acceleration unit is configured to operate multiplexers to route state information between the ChaCha rounds.

9. The system of claim 1, wherein the hardware acceleration unit comprises four ChaCha quarter round units configured to operate in parallel.

10. A system comprising:
one or more data processors;
a hardware acceleration unit;
a random number generator configured with a cryptographic primitive that, when executed by the one or more processors, operates the hardware acceleration unit to perform at least one Keccak round.

11. The system of claim 10, wherein the cryptographic primitive operates the hardware acceleration unit to perform multiple Keccak rounds.

12. The system of claim 10, wherein the cryptographic primitive comprises a parameter to set a number of Keccak rounds for the hardware acceleration unit to perform.

13. The system of claim 10, further comprising:
a neural network; and
training logic configured to apply an output of the random number generator to set a dropout rate for the neural network.

14. The system of claim 10, wherein the random number generator is multithreaded.

15. The system of claim 14, wherein the random number generator is configured to apply thread shuffling to route state information between the Keccak rounds.

16. The system of claim 14, wherein multiple threads of the random number generator are configured to cooperate to combine results returned from execution of the cryptographic primitive.

17. The system of claim 10, wherein the hardware acceleration unit is configured to generate a count value.

18. The system of claim 10, wherein the hardware acceleration unit is configured to output the count value packed with a partial state value.

19. A process for configuring a neural network structure, the process comprising:
invoking a random number generator from multiple software threads executing in parallel, the random number generator invoked from each thread by way of a software cryptographic primitive that, when executed by the one or more data processors, operates the hardware acceleration unit to perform at least one ChaCha round; and
merging, in the multiple threads, results returned by the cryptographic primitive into a cryptographically insecure value; and
applying the cryptographically insecure value to set a dropout rate for a neural network.

20. A process for configuring a neural network structure, the process comprising:
invoking a random number generator from multiple software threads executing in parallel, the random number generator invoked from each thread by way of a software cryptographic primitive that, when executed by the one or more data processors, operates the hardware acceleration unit to perform at least one Keccak round; and
merging, in the multiple threads, results returned by the cryptographic primitive into a cryptographically insecure value; and
applying the cryptographically insecure value to set a dropout rate for a neural network.
